(19) United States
(12) Patent Application Publication
(10) Pub. No.: US 2009/0265490 A1
(43) Pub. Date: Oct. 22, 2009

(54) High-Speed Video Serializer and Deserializer

(76) Inventors: Tarun Setya, Pleasanton, CA (US); Cristian Samoila, Kanata (CA); Poupak Khodabandeh, Huntington Beach, CA (US)

Correspondence Address: PATENT GROUP 2N;JONES DAY, NORTH POINT, 901 LAKESIDE AVENUE, CLEVELAND, OH, 44114, US

(21) Appl. No.: 12/417,303

(22) Filed: Apr. 2, 2009

Related U.S. Application Data
(60) Provisional application No. 61/042,471, filed on Apr. 4, 2008.

(51) Int. Cl. G06F 13/38; G06F 1/08

(52) U.S. Cl. 710/71; 713/401

(57) ABSTRACT

A high-speed video serializer has an X bit parallel input bus and a Y bit parallel output bus, where X and Y are multiples of one another (e.g., 2). A multiplexer is connected between the input bus and the output bus and is operated such that a frequency of the signals on the output bus is a multiple of the frequency of the signals on the input bus. A circuit provides a clock signal substantially in sync with the signals on the output bus. A high speed video deserializer is also disclosed as are methods of operating the serializer and deserializer.

The present application claims the benefit of copending U.S. Ser. No. 61/042,471 filed Apr. 4, 2008 and entitled High-Speed Video Serializer and Deserializer the entirety of which is hereby incorporated by reference for all purposes.

### TECHNICAL FIELD

The technology described in this document relates generally to the field of digital audio/video signal processing. More particularly, this document describes a high-speed video serializer and deserializer.

### BACKGROUND

At present, if board designers want to transmit or receive 3 Gb/s SDI to/from a field-programmable gate array (FPGA), they have two options. First, they may use high-speed transceiver I/Os such as those included on Xilinx Virtex 5 FPGAs (Rocket IOs) or the high-speed transceivers on Altera's Stratix II GX series of FPGAs. Second, they may use a 20-bit parallel interface with clock and data operating at 148.5 MHz. The first option is problematic due to the jitter performance of high-speed transceivers, the high cost of FPGAs with these transceivers, and the limited number of high-speed transceivers on one FPGA. The second option presents the problems: (1) that it uses many I/Os on the FPGA, where in many cases FPGA designs run out of I/Os before they run out of logic, so I/Os are at a premium, and (2) because the parallel interface has so many traces, it is not suitable for running across a backplane or for designing a small daughter card.

Two commercially available products that address the above problems are the National Semiconductor LMH0340 3 Gb/s serializer and LMH0341 3 Gb/s deserializer. These products provide 3-Gb/s serialization and deserialization functions, and reduce the parallel bus between the serializer and FPGA from a 20-bit single-ended interface to a 5-bit low-voltage differential signaling (LVDS) interface. This simplifies board layout by reducing the number of traces between the serializer, deserializer and FPGA. The LVDS signaling scheme reduces electromagnetic interference (EMI), while the narrow parallel bus enables a single low-cost FPGA to support a greater number of high-speed video channels.

The National Semiconductor products consist of 5 differential LVDS data lanes and one differential LVDS clock lane (for a total of 12 required FPGA pins). The maximum FPGA pin speed is 600 Mb/s (DDR pixel clock) which is achievable using dedicated LVDS lanes in the FPGA. The National deserializer does not do descrambling and word alignment, so the FPGA must further demultiplex the 5-bit bus to 10 or 20 bits, and then perform these operations to detect timing reference signals. In addition, the National serializer does not do SMPTE scrambling, so this operation must be done in the FPGA, along with partial serialization (20 bits to 5 bits). In the event there is excess skew on the board between the deserializer and the FPGA (>1 data word), the scrambled data bits may appear out of order at the input of the deserializer. When this misaligned data is descrambled, the output will appear to be corrupted—no video or timing reference signals (TRS) can be extracted. Therefore, skew must be very carefully managed during layout. LVDS I/Os, due to differential design, are inherently more noise immune than LVCMOS, and generate less EMI as long as the trace layout is done carefully on the board.

### SUMMARY

The improvement described herein is a transmitter/receiver (also known as an SDI serializer/deserializer) with the ability to receive/transmit 10-bit parallel video data with a dual-data rate (DDR) pixel clock over a single-ended interface. The DDR clock is used when the SDI data bandwidth is 3 Gb/s. In this case, the 10-bit parallel data rate is 297 Mb/s, and the frequency of the DDR clock is 148.5 MHz. One benefit of the disclosed parallel data interface is to reduce the number of pins required to connect the transmitter and receiver devices with FPGAs in the video system. Because the parallel bus is single-ended, the total number of required pins is 11 (10-bits data+1-bit pixel clock). This is of significance because FPGA designs are often pin-limited. In addition, the DDR pixel clock avoids the need to operate a high-drive pixel clock at 297 MHz, which reduces power consumption, clock drive strength requirement, and noise generation. It also enables easier board routing and avoids the need to use the higher-speed I/Os on FPGAs, which may require more expensive speed grades. FIG. 1 demonstrates how the DDR interface operates. The pixel clock is transmitted at half the data rate, and the interleaved data is sampled at the receiver on both clock edges.

According to one embodiment, a high-speed video serializer is comprised of an X bit parallel input bus and a Y bit parallel output bus, where X and Y are multiples of one another (e.g., 2). A multiplexer is connected between the input bus and the output bus and is operated such that a frequency of the signals on the output bus is a multiple of the frequency of the signals on the input bus. A circuit provides a clock signal substantially in sync with the signals on the output bus.

According to another embodiment, a high-speed video deserializer is comprised of an X bit parallel input bus responsive to received data signals, and a Y bit parallel output bus. The X and Y buses are multiples of one another (e.g., 2). A circuit receives and provides a sampling clock signal substantially in sync with the signals on the input bus. A splitter circuit is responsive to the input bus and a first data sampling circuit is responsive to the splitter circuit for detecting data on a positive edge of the sampling clock. A second data sampling circuit is responsive to the splitter circuit for detecting data on a negative edge of the sampling clock. The Y bit parallel output bus is responsive to the first and second data sampling circuits.

Methods of operating the disclosed serializer and deserializer are also disclosed.

### BRIEF DESCRIPTION OF THE FIGURES

For the disclosed improvement to be easily understood and readily practiced, the disclosed improvement will now be described, for purpose of illustration and not limitation, in conjunction with the following figures.

FIG. 1 illustrates how the disclosed dual data rate interface operates.

FIG. 2 is a block diagram of one embodiment of a dual data rate serializer according to the present disclosure.

FIG. 3 is a block diagram of one embodiment of a dual data rate deserializer according to the present disclosure.

FIGS. 4A and 4B are block diagrams illustrating two potential locations for the disclosed serializer.

### DETAILED DESCRIPTION

The disclosed improvement reduces the parallel FPGA interface to only 11 pins: 10 single-ended data lanes plus one single-ended DDR clock lane. The maximum operating data rate with a 148.5 MHz DDR clock is 297 Mbps, which is achievable in low-cost FPGAs. Because the receiver will also perform SMPTE descrambling as well as word alignment (to detect timing reference signals), the FPGA can process the data immediately, without further deserialization or word alignment. In addition, because the transmitter performs SMPTE scrambling, the FPGA can output 10-bit data without having to do the scrambling step. Both the transmitter (serializer) and the receiver (deserializer) have the ability to modify the setup/hold window in the case of the transmitter and the clock to output data delay in the case of the receiver to accommodate a wide range of board layouts.

In contrast to known solutions to the problem of transmitting or receiving 3 GB/s SDI to or from a FPGA, the transmitter and receiver devices described herein consist of 10 single-ended data lanes and one single-ended clock lane (for a total of 11 required FPGA pins). The maximum FPGA pin speed is 300 Mb/s (DDR) which is achievable even in lower-cost FPGAs. Because the receiver also performs SMPTE descrambling and word alignment, the FPGA can process the parallel data immediately, without further demultiplexing. In the transmitter, the FPGA can output interleaved parallel data on the 10-bit bus, without the need for additional partial serialization or scrambling.

Another benefit of the disclosed improvement described herein is that if there is excess skew on the board between the receiver and the FPGA (>1 data word), the TRS words can still be recovered using a training algorithm inside the FPGA, because the data is already word aligned to the TRS boundaries. Because the I/Os of the disclosed improvement are run at half the rate of those in the National Semiconductor products, the disclosed improvement can tolerate more board-level skew and can compensate for skew using an internal delay circuit to shift the position of the output pixel clock relative to the data.

LVCMOS I/Os are not as noise immune as LVDS, and may require more decoupling as well as termination components. Additionally, this switching noise makes it difficult to control EMI, although the I/Os can work at 1.8 V instead of 3.3 V, which helps.

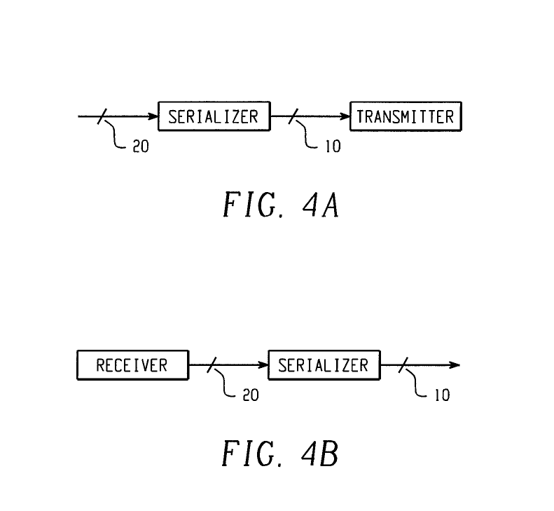

Benefits of the disclosed improvement include: fewer lanes going into a 3 Gb/s SDI transmitter (See FIG. 4A), or out of a 3 Gb/s SDI receiver (See FIG. 4B); among others, LVCMOS-compatible interface does not require on-board termination between the FPGA and transmitter/receiver; dual data rate pixel clock allows the clock I/O cell to operate at half the power compared to a single data rate solution; ability to adjust the clock to output data delay on the transmit interface; and ability to shift the setup/hold window on the receive interface.

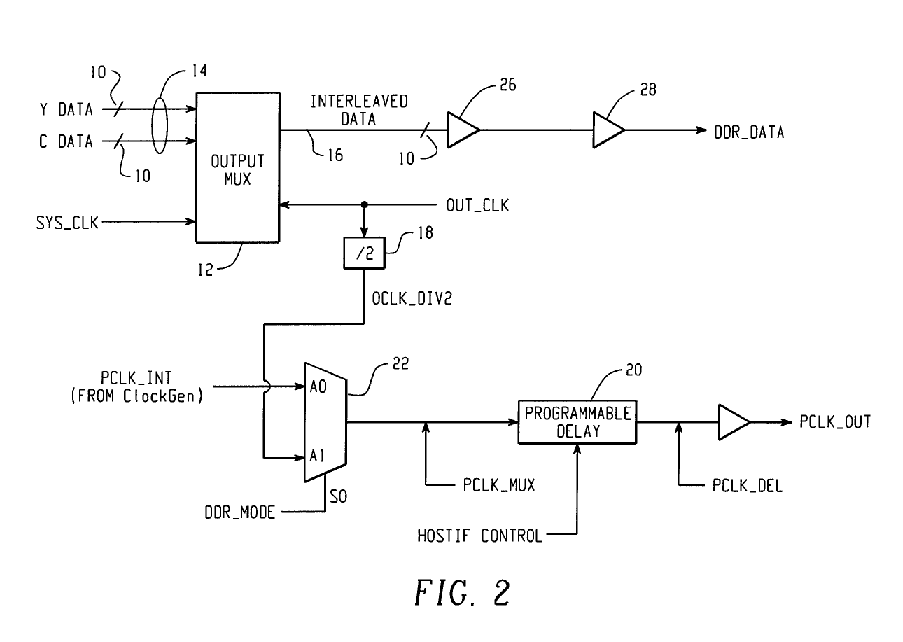

An exemplary dual data rate transmit interface (serializer) is shown in FIG. 2.

SDI data operating at 3 Gb/s is mapped in the parallel domain to a 20-bit interface, operating at 148.5 Mb/s. The final output stage has a multiplexer 12 for multiplexing the 20-bit input bus 14 to a 10-bit output bus 16 in a dual data rate mode (DDR mode or DDR_DATA). The output bus 16 is comprised of low-voltage, CMOS compatible lines. The output pixel clock (PCLK_OUT) is the multiplexer's output clock (OUT_CLK) divided by two by divider 18, and is derived from the same clock leaf as is used to clock the interleaved data out of the output multiplexer 12. Note that in this embodiment OUT_CLK operates internally at 297 MHz. Multiplexer 12 may be implemented using any hardware capable of providing the disclosed function.

The period of each data word (running at 297 Mb/s) is 3.367 ns. This does not allow for much variation of output hold and delay (toh and tod, respectively) over process, voltage and temperature, so the circuit is designed to attempt to balance the PCLK_OUT and DDR_DATA delay as much as possible to reduce delay variation over PVT. A programmable delay circuit 20 is placed in the PCLK_OUT path to allow finer phase adjustment, if necessary, to compensate for data skew on the board. This adjustment is at a resolution well below one pixel clock period. A multiplexer 22 selects the appropriate clock depending on whether the DDR mode of operation is active. Multiplexer 22 may be implemented using any hardware capable of providing the disclosed function.

Additional buffering of the DDR_DATA is provided by buffers 26, 28 and is done to match the nominal default delay through the delay circuit in the PCLK_OUT path. This delay should be minimal, and the buffer delay should correlate quite well. Because the PCLK_OUT and DDR_DATA pins use the same I/O cell type, the delay through the output buffers 26, 28 should be well matched, with a result that PCLK_OUT and DDR_DATA are nearly aligned.

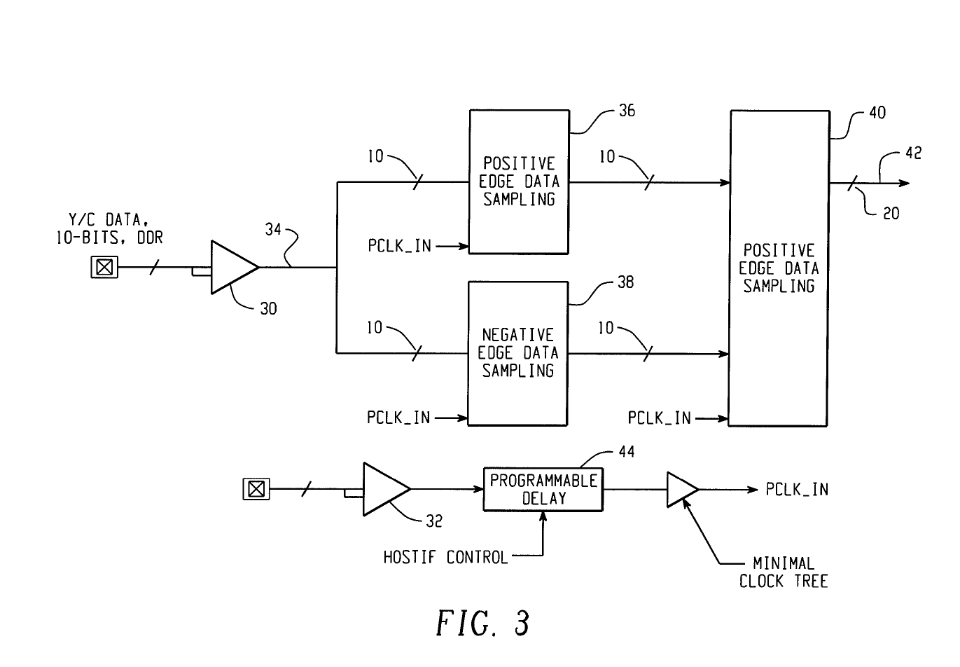

An exemplary dual data rate receive interface (deserializer) for a transmitter is shown in FIG. 3.

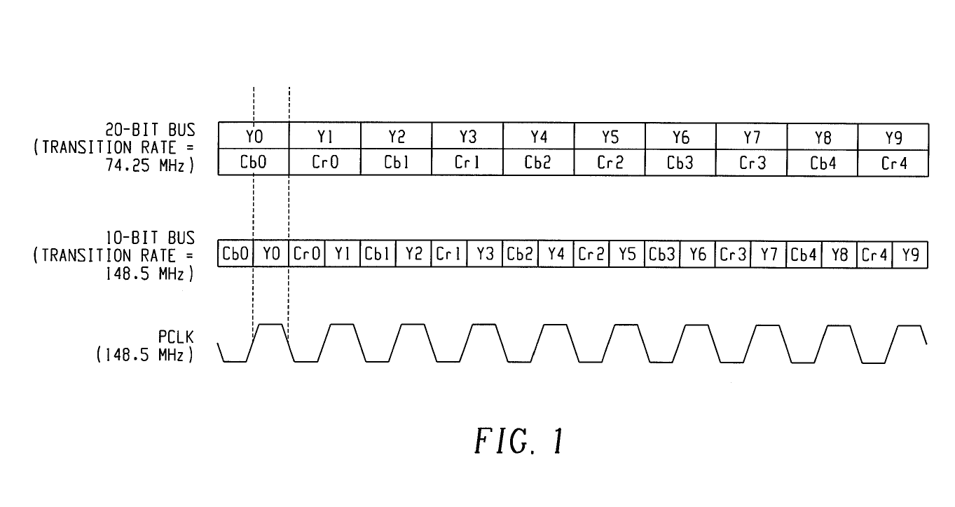

A 10-bit DDR input data bus 34 responsive to a receiver 30 operates on both edges of a received clock (See FIG. 1) received at a receiver 32. The input data bus 34 is comprised of low-voltage, CMOS compatible lines. The input data bus 34 is split and sampled in the receive interface of the transmitter on both the positive edge of the clock by sampler 36 and the negative edge of the incoming clock by sampler 38. The samplers 36 and 38 may be followed by a second sampling stage 40 at the same clock rate but this time sampling the ten bits received on the positive edge of the clock and the ten bits received on the negative edge of the clock into a twenty-bit internal data bus 42 sampled on the positive edge of the clock. Thus, the twenty-bit data bus 42 illustrated in FIG. 3 is reconstructed from the received ten-bit data bus 34. The sampling provided at 36, 38, and 40 may be provided by any known types of hardware.

The exemplary transmitter DDR receive interface shown in FIG. 3 includes a programmable delay circuit 44 in the clock path to accommodate a wider range of skew on the board and compensate for the inability of some transmitters to guarantee that the clock and data are aligned, with the data always lagging the clock if not perfectly aligned. Thus, the setup and hold window of the transmitter can be moved to prevent potential hold time violations in the system. This adjustment is at a resolution well below the one pixel clock period. In case this adjustment is used, one of the trade-offs is an increase in the size of the setup and hold window of the receive interface to accommodate the PVT variations that might be introduced by the programmable delay adjustment circuitry.

By connecting between an FPGA and a transmitter/receiver with a low pin count data bus, the present solution permits running the data as fast as possible for a low-cost FPGA, and minimizing pin usage on the FPGA, which is at a premium. Because the exemplary parallel bus is single-ended, the total number of required pins is 11 (10-bits data+1-bit pixel clock). In addition, operating with a DDR pixel clock avoids the need to operate a high-drive pixel clock at 297 MHz, which reduces power consumption, clock drive strength requirement, and noise generation. It also enables easier board routing and avoids the need of using the higher-speed I/Os on FPGAs, which require more expensive speed grades. Further, the LVCMOS interface is also simple to design with. Finally, board routing is further simplified by the additional capability of the transmitter and receiver to change the setup/hold window and clock to output data delay respectively for the DDR interface.

Although the present disclosure describes a method and apparatus in terms of one or more embodiments, many modifications and variations are possible. For example, one or more steps of methods described above may be performed in a different order and still achieve desirable results. The following claims are intended to encompass all such modifications and variations.

It is claimed:

1. A high-speed video serializer, comprising:
an X bit parallel input bus and a Y bit parallel output bus, where X and Y are multiples of one another;
a multiplexer connected between said input bus and said output bus, said multiplexer operated such that a frequency of the signals on said output bus is a multiple of the frequency of the signals on said input bus; and
a circuit for providing a clock signal substantially in sync with the signals on said output bus.

2. The video serializer of claim 1 wherein said output bus is comprised of low-voltage, CMOS compatible, single-ended lines.

3. The video serializer of claim 1 wherein X equals 20 and Y equals 10.

4. The video serializer of claim 1 wherein said circuit for providing a clock signal comprises a divider responsive to a signal input to said multiplexer and a programmable delay circuit responsive to said divider.

5. The video serializer of claim 1 additionally comprising another multiplexer connected between said divider and said programmable delay circuit.

6. A method of operating a high-speed video serializer, comprising:
multiplexing a signal on an X bit parallel input bus onto a Y bit parallel output bus such that a frequency of the signal on said output bus is a multiple of a frequency of the signal on said input bus; and
generating a clock signal substantially in sync with the signal on said output bus.

7. The method of claim 6 wherein said generating a clock signal comprises dividing a clock signal used for the multiplexing by the multiple that relates the frequency of the signal on said output bus to the frequency of the signal on said input bus, and delaying said divided clock signal by a programmable amount to provide said clock signal substantially in sync with the signal on said output bus.

8. The method of claim 6 wherein the frequency of the signal on said input bus is nominally 74.25 MHz, the frequency of the signal on said output bus is nominally 148.5 MHz, and a frequency of said clock signal substantially in sync with the signals on said output bus is nominally 148.5 MHz.

9. The method of claim 6 wherein the frequency of the signal on said output bus is twice the frequency of the signal on said input bus, and wherein said clock signal substantially in sync with the signal on said output bus is a dual data rate signal.

10. A high-speed video deserializer, comprising:
an X bit parallel input bus responsive to received data signals and a Y bit parallel output bus, where X and Y are multiples of one another;
a circuit for receiving and providing a sampling clock substantially in sync with the signal on said input bus;
a splitter responsive to said input bus;
a first data sampling circuit responsive to said splitter for detecting data on a positive edge of said sampling clock; and
a second data sampling circuit responsive to said splitter for detecting data on a negative edge of said sampling clock, and wherein said Y bit parallel output bus is responsive to said first and second data sampling circuits.

11. The video deserializer of claim 10 additionally comprising a third data sampling circuit responsive to said first and second data sampling circuits, said Y bit parallel output bus being responsive to said third data sampling circuit.

12. The video deserializer of claim 10 wherein said input bus is comprised of low-voltage, CMOS compatible, single-ended lines.

13. The video deserializer of claim 10 wherein X equals 10 and Y equals 20.

14. The video deserializer of claim 10 wherein said circuit for providing a clock signal comprises a receiver and a programmable delay circuit.

15. A method of operating a high-speed video deserializer, comprising:
receiving data signals at an X bit parallel input bus and receiving a sampling clock;
delaying said received sampling clock by a programmable amount to produce a clock signal substantially in sync with the signal on said input bus;
splitting said X bit parallel input bus into two X bit input buses;
detecting data on a positive edge of said sampling clock in one of said two X bit input buses; and
detecting data on a negative edge of said sampling clock in the other of said two X bit input buses, and wherein a Y bit parallel output bus is responsive to said data detecting, and wherein X and Y are multiples of one another.

16. The method of claim 15 wherein the frequency of the signal on said output bus is nominally 74.25 MHz, the frequency of the signals on said input bus is nominally 148.5 MHz, and a frequency of said clock signal substantially in sync with the signals on said input bus is nominally 148.5 MHz.

17. The method of claim 15 wherein the frequency of the signals on said input bus is twice the frequency of the signals on said output bus, and wherein said clock signal substantially in sync with the signals on said input bus is a dual data rate signal.
